(19) United States
(12) Patent Application Publication
(10) Pub. No.: US 2024/0301983 A1
(43) Pub. Date: Sep. 12, 2024

(54) Guide Apparatus

(71) Applicant: Advanced Innergy Ltd, Gloucester (GB)

(72) Inventor: Gregory Stanley VAN HINSBERGH, Gloucester (GB)

(21) Appl. No.: 18/560,331

(22) PCT Filed: May 11, 2022
(86) PCT No.: PCT/GB2022/051201

§ 371 Date: Nov. 10, 2023

(30) Foreign Application Priority Data
May 13, 2021 (GB) 2106838.2
May 27, 2021 (GB) 2107552.8

(51) Int. Cl. F16L 57/02; F16L 1/12

(52) U.S. Cl. CPC F16L 57/02; F16L 1/123

(57) ABSTRACT

A guide apparatus 10 for an elongate member. The guide apparatus 10 comprises a plurality of elements 12 locatable along the length of the elongate member. Each element 12 extends around the elongate member. The guide apparatus 10 comprises a plurality of elongate link members 14 extending between elements 12. The elongate link members 14 are spaced from each other around the elements 12. The elongate link members 14 permit limited relative movement of the respective elements 12, such that the guide apparatus 10 permits limited bending of the elongate member. The guide apparatus 10 comprises a plurality of spacers 16. The spacers 16 are disposed between the elements 12. The spacers 16 extend around the elongate member. The spacers comprise guide formations 18, through which guide formations 18 the elongate link members 14 extend between the elements 12.

### CROSS-REFERENCE TO RELATED APPLICATIONS

This application is a U.S. National Stage of International Patent Application No. PCT/GB2022/051201 filed May 11, 2022, which claims priority to United Kingdom Patent Application No. 2106838.2 filed May 13, 2021 and United Kingdom Patent Application No. 2107552.8 filed May 27, 2021, all of which are incorporated by reference herein as if reproduced in their entireties.

### TECHNOLOGICAL FIELD

Examples of the disclosure relate to guide apparatus, and particularly to guide apparatus for an elongate member.

### BACKGROUND

In a number of situations, it is required to provide a guide apparatus for an elongate member, such as a pipeline or cable, which restricts the amount of bending of the elongate member overall and provides protection from impact, and for instance at particular locations. A number of prior arrangements have been proposed. However, such known arrangements can be prone to failure under high loads experienced in some applications, for example, subsea applications.

Accordingly, there is a requirement to provide improved guide apparatus.

### BRIEF SUMMARY

According to various, but not necessarily all, examples of the disclosure there is provided a guide apparatus for an elongate member, the guide apparatus comprising:
a plurality of elements locatable along the length of the elongate member, with each element extending around the elongate member;
a plurality of elongate link members extending between elements, the elongate link members being spaced from each other around the elements, the elongate link members permitting limited relative movement of the respective elements, such that the guide apparatus permits limited bending of the elongate member;
a plurality of spacers, wherein the spacers are disposed between the elements, the spacers extending around the elongate member, wherein the spacers comprise guide formations, through which guide formations the elongate link members extend between the elements.

Possibly, each of the plurality of elongate link members is connected to at least two elements. Possibly, adjacent elongate link members on at least some of the elements extend in opposite directions to each other, to each connect to just one other respective element. Possibly, at least some of the elongate link members extend through a plurality of elements, wherein the elongate link members are connected to each of the plurality of elements through which they extend.

Possibly, fastening means engage with the elongate link members to connect the elongate link members to the elements. Possibly, the guide apparatus comprises fastening means made of different materials at different parts of the guide apparatus to provide different material properties.

Possibly, the fastening means locate through openings in the elements to engage with the elongate link members.

Possibly, the elements comprise adjoining openings extending into the openings, wherein elongate link members extend through the adjoining openings into the openings. In at least some of the elements, the openings may be at an angle of 90 degrees to the adjoining openings. In at least some of the elements the openings may be at an angle other than 90 degrees to the adjoining openings.

Possibly, the fastening means extend through openings in the elongate link members to engage with the elongate link members.

Possibly, the elements and the spacers are disposed end to end, wherein the ends of the spacers each define a male formation and the ends of the elements each define a female formation, wherein the male formations on each end of the spacers are locatable in female formations of adjoining elements. The male and female formations may provide a ball and socket interconnection. Possibly, the male and female formations are configured to permit a predetermined amount of relative pivotal movement between spacers and adjacent elements.

Possibly, the elongate link members are different at different parts of the apparatus, to provide different stiffnesses and/or permit different amounts of flexing of an elongate member and/or depending on the load the different parts of the guide apparatus are subjected to in use.

Possibly, at least six elongate link members are connected to at least some of the elements. Possibly, at least twelve elongate link members are connected to at least some of the elements. Possibly, at least six elongate link members are connected to some of the elements and at least twelve elongate link members are connected to others of the elements.

The elements and spacers may be made of different materials. Possibly, the elements and/or spacers are made of different materials at different parts of the guide apparatus to provide different material properties.

Possibly, a filler material is located in at least some of spacers, wherein the filler material is either lighter or heavier than water to respectively provide buoyancy or assist with sinking in water and on bottom stability. The filler material may be provided on one side only of the spacers to provide orientation thereof in water.

Possibly, at least some of the spacers comprise ground engaging means.

Possibly, the ground engaging means comprises projections extending radially from the spacer.

The ground engaging means may be integrally formed with the spacer.

Alternatively, the ground engaging means may be attachable to the spacer by fastening means.

Possibly, at least some of the spacers are made of concrete.

Possibly, the guide apparatus comprises positioning rings in at least some of the spacers and/or elements for positioning the elongate member, wherein the positioning rings are configured to cause the elongate member to adopt the neutral axis in the guide apparatus.

According to various, but not necessarily all, examples of the disclosure there may be provided examples as claimed in the appended claims.

### BRIEF DESCRIPTION

For a better understanding of various examples that are useful for understanding the detailed description, reference will now be made by way of example only to the accompanying drawings in which:

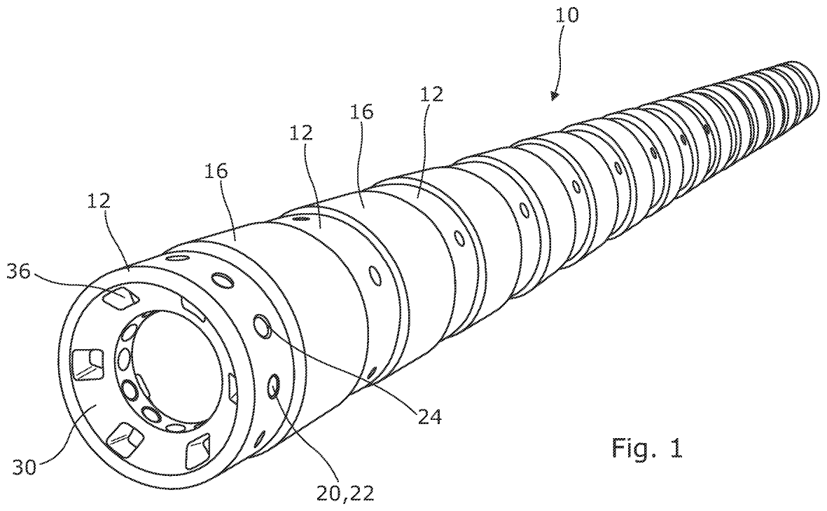

FIG. 1 illustrates a perspective view of a guide apparatus in a straight condition;

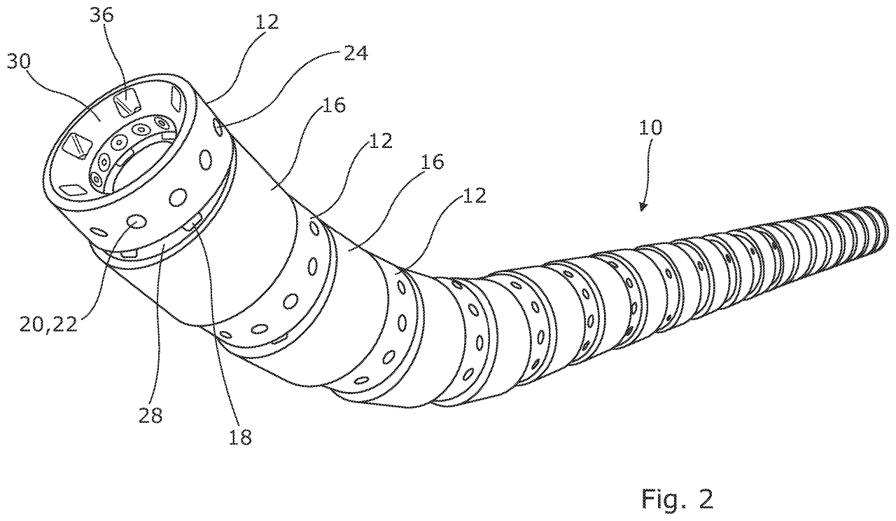

FIG. 2 illustrates a perspective view of the guide apparatus of FIG. 1 in a bent condition;

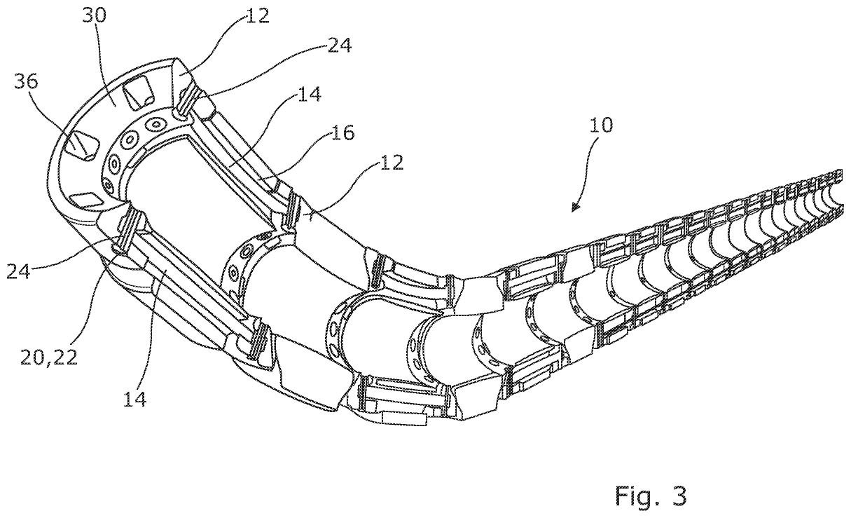

FIG. 3 illustrates a cross-sectional view of the guide apparatus of FIGS. 1 and 2;

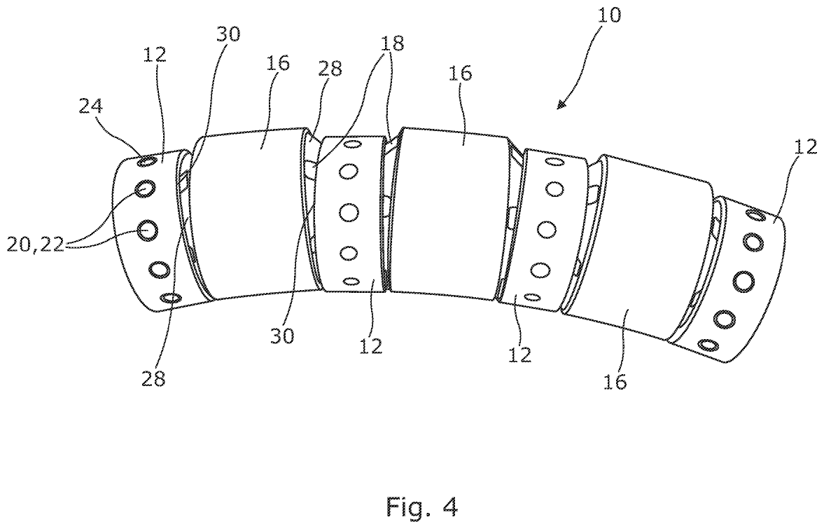

FIG. 4 illustrates a side view of the bent part of the guide apparatus of FIGS. 1 and 2;

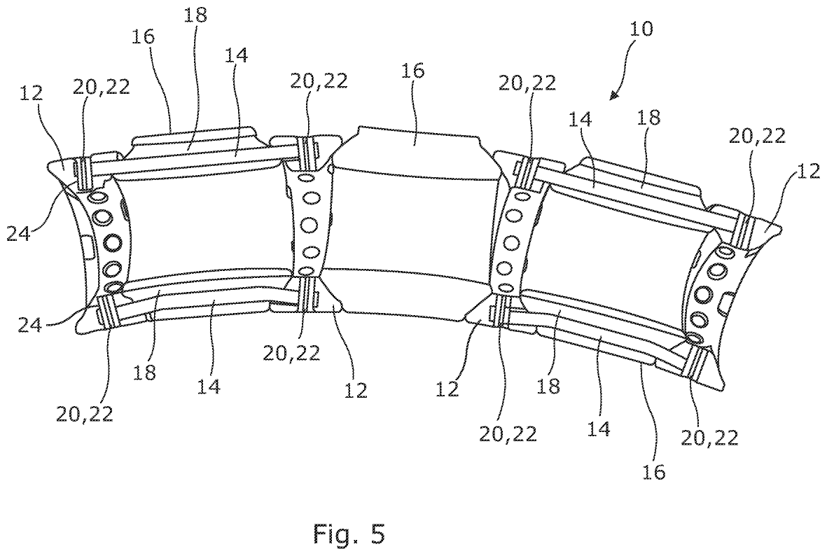

FIG. 5 illustrates a cross-sectional view of the part of the guide apparatus of FIG. 4;

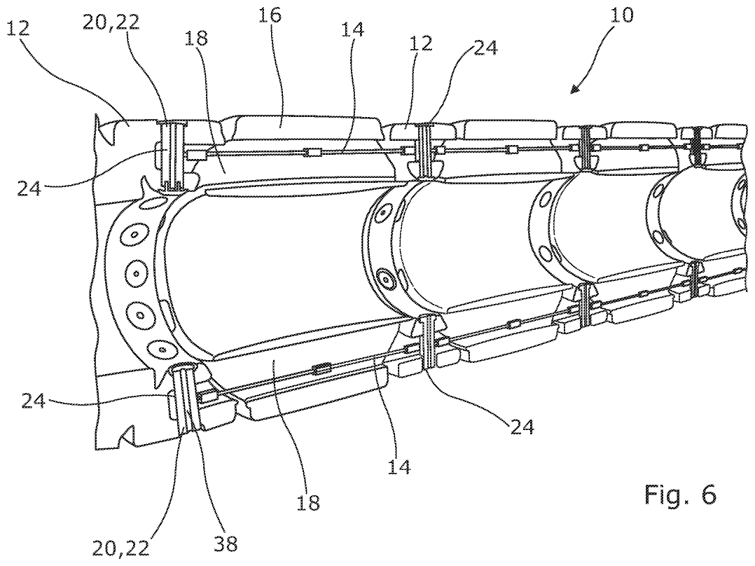

FIG. 6 illustrates a cross-sectional view of the straight part of the guide apparatus of FIGS. 1 and 2;

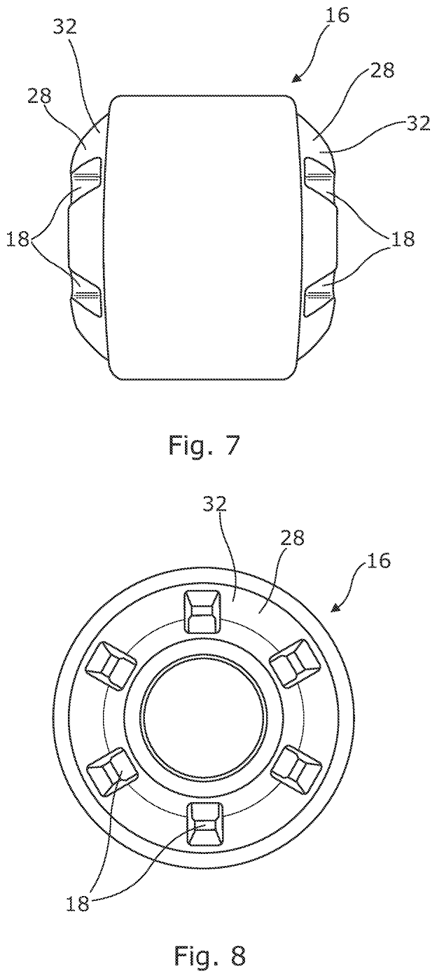

FIG. 7 illustrates a side view of spacer;

FIG. 8 illustrates a view from one end of the spacer of FIG. 7;

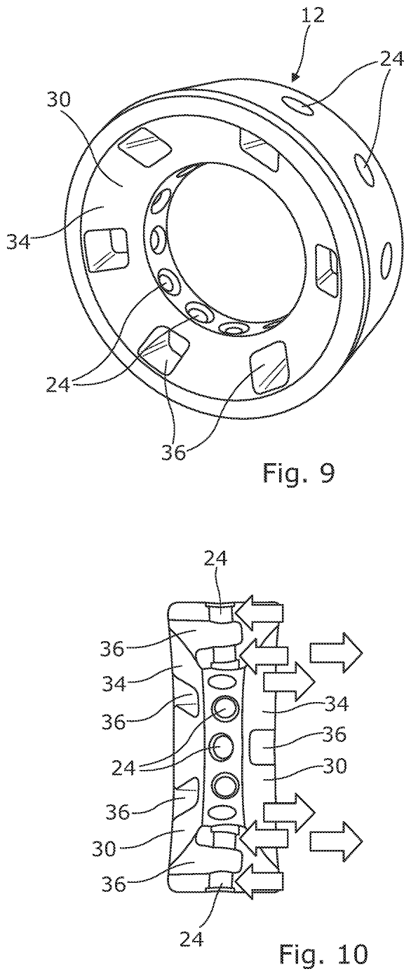

FIG. 9 illustrates a perspective view of an element;

FIG. 10 illustrates a sectional perspective view of the element of FIG. 9;

FIG. 11 illustrates a perspective view of another element;

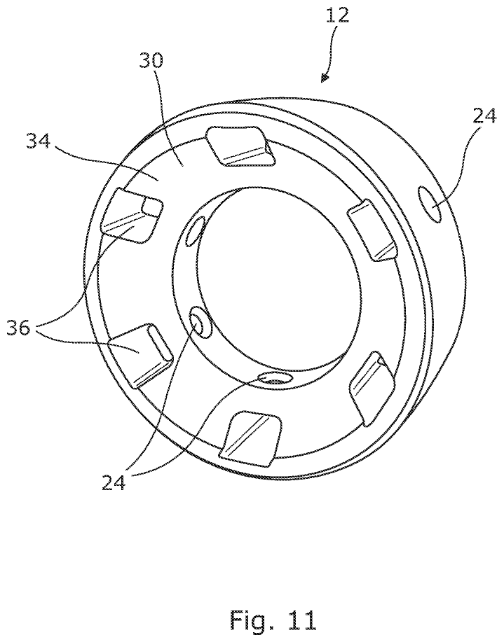

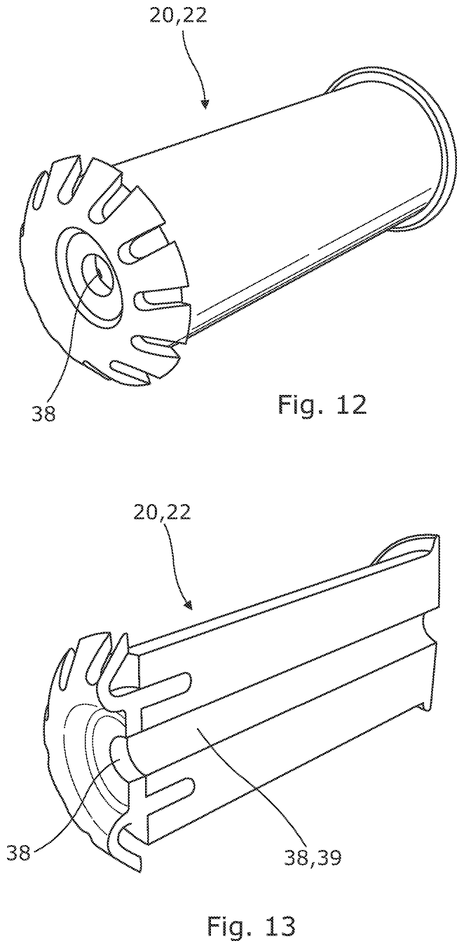

FIG. 12 illustrates a perspective view of fastening means;

FIG. 13 illustrates a cross-sectional view of the fastening means of FIG. 12;

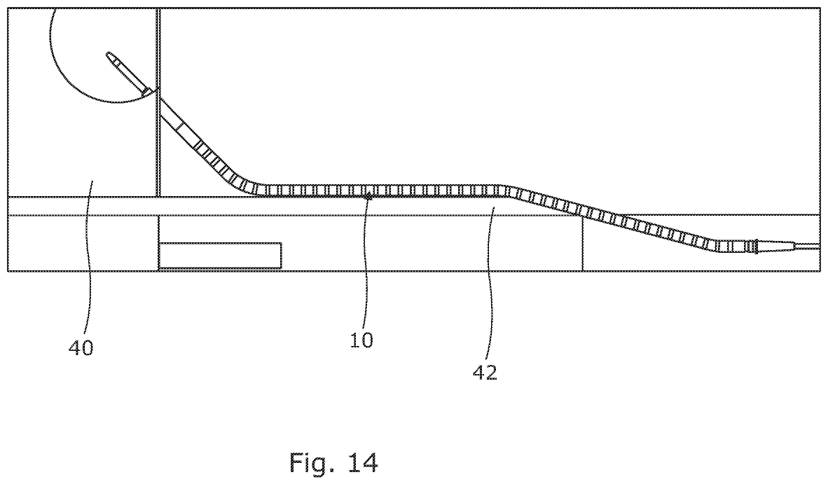

FIG. 14 illustrates another guide apparatus in use subsea;

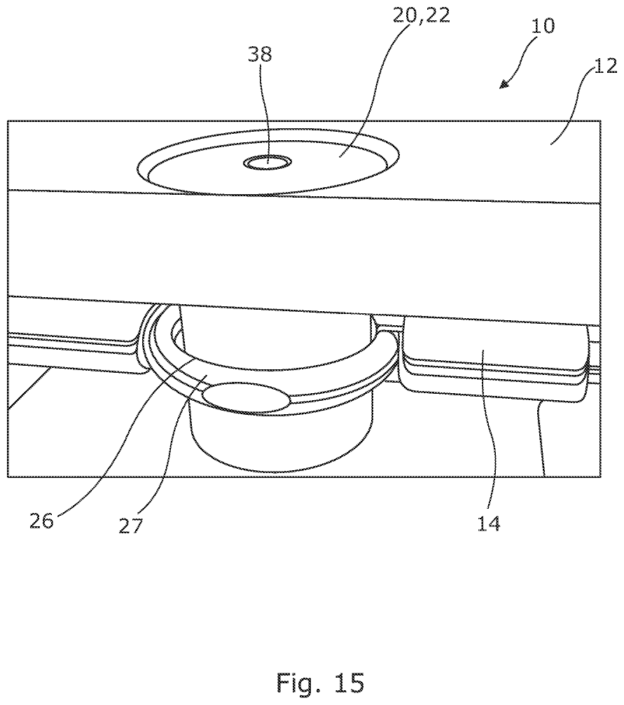

FIG. 15 illustrates an expanded view of an element of the part of the guide apparatus of FIG. 6, but in perspective view;

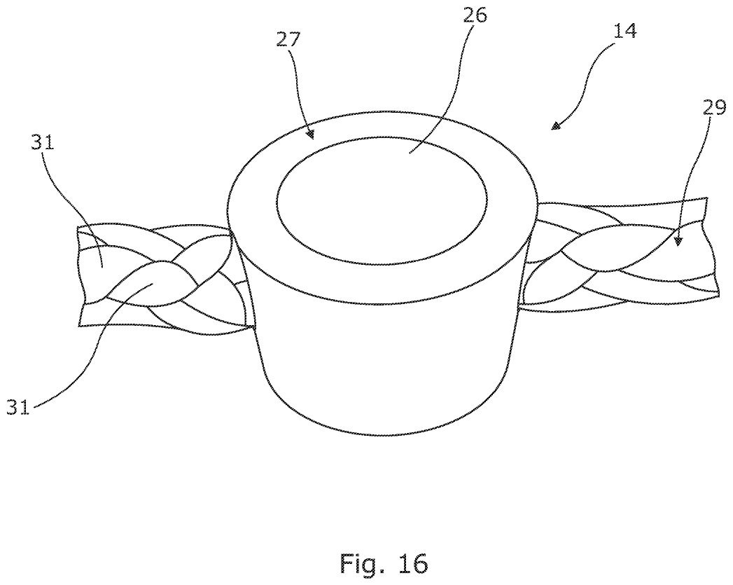

FIG. 16 illustrates an elongate link member according to examples of the disclosure;

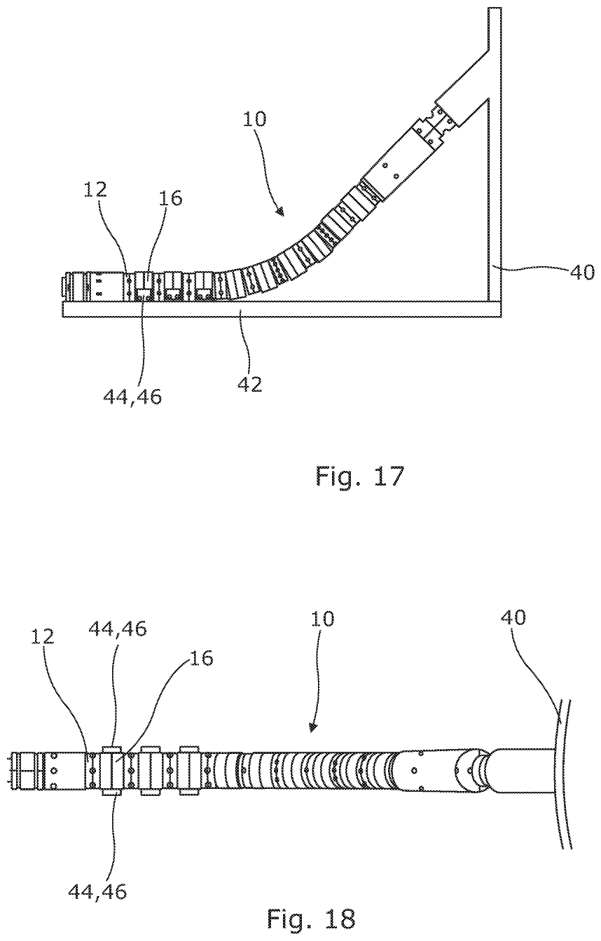

FIG. 17 illustrates another guide apparatus in use subsea viewed from one side;

FIG. 18 illustrates the guide apparatus of FIG. 17 from above;

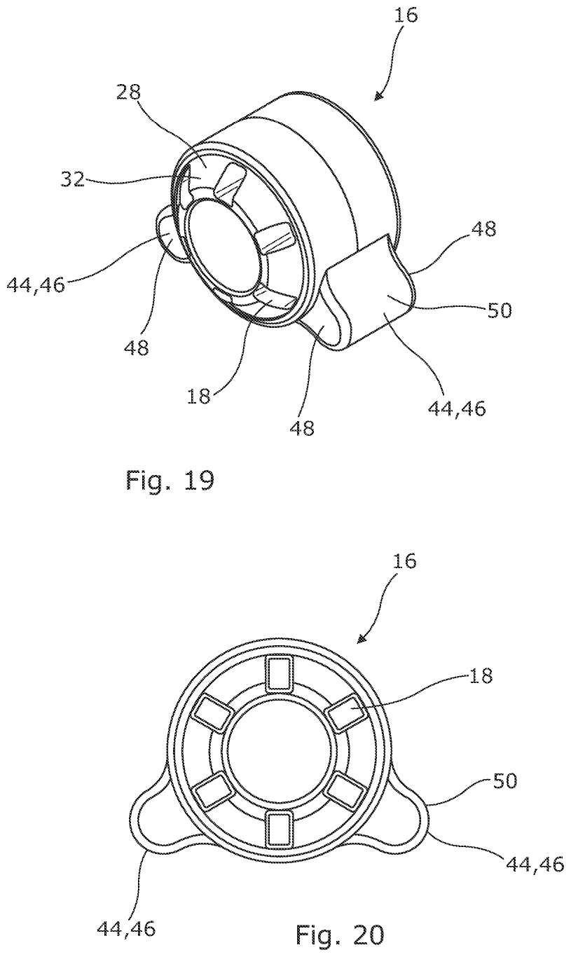

FIG. 19 illustrates a perspective view of another spacer;

FIG. 20 illustrates a cross-sectional view of the spacer of FIG. 19;

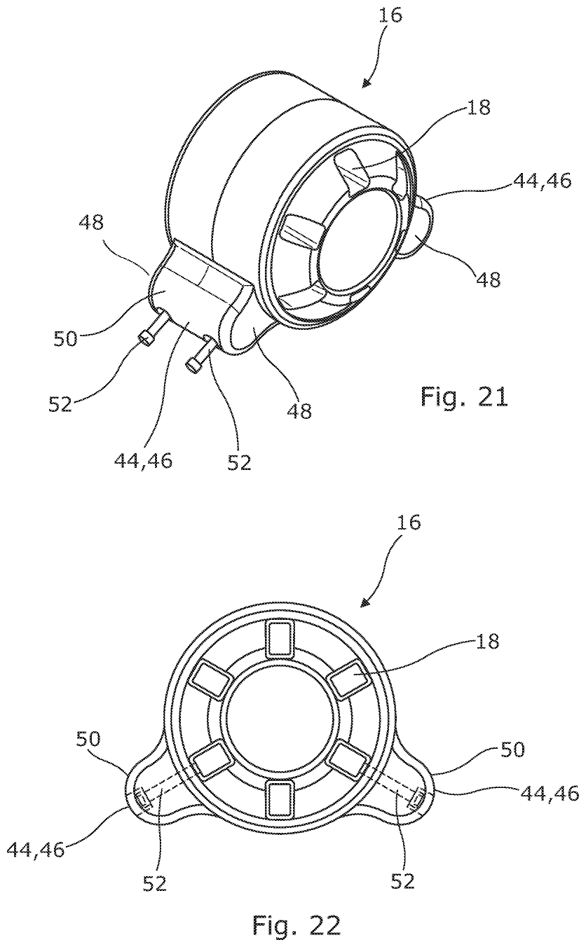

FIG. 21 illustrates a perspective view of another spacer;

FIG. 22 illustrates a cross-sectional view of the spacer of FIG. 21;

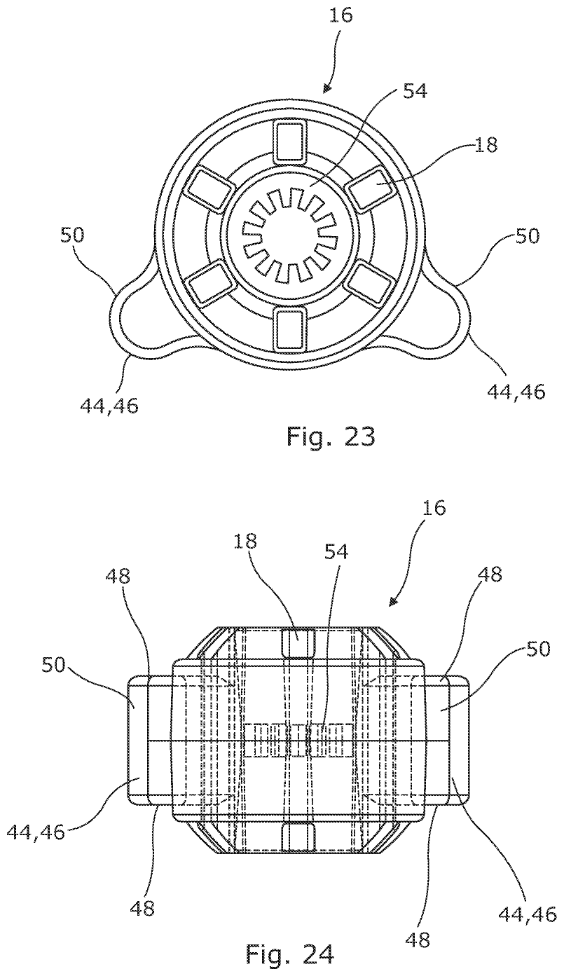

FIG. 23 illustrates a cross-sectional view of another spacer;

FIG. 24 illustrates a transparent view of the spacer of FIG. 23 viewed from above; and

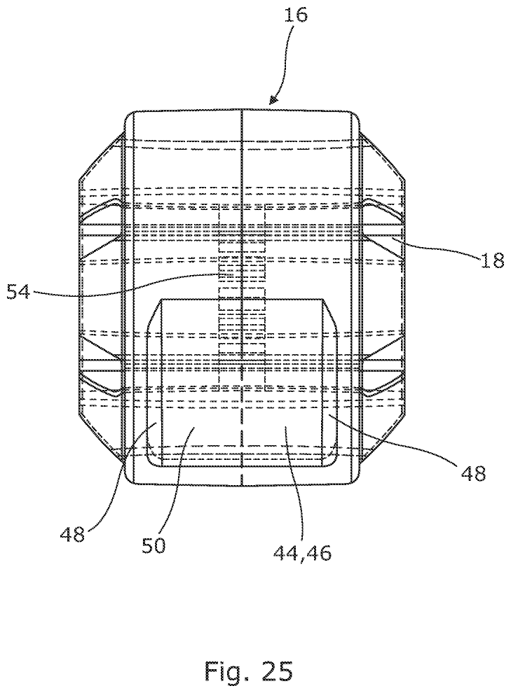

FIG. 25 illustrates a transparent view of the spacer of FIG. 23 viewed from one side.

### DETAILED DESCRIPTION

The figures illustrate a guide apparatus 10 for an elongate member such as a pipeline or cable, and in particular a subsea pipeline or cable. Guide apparatus 10 according to examples of the disclosure restrict the amount of bending of the elongate member overall and provide protection from impact, and for instance at particular locations. In some examples of the disclosure the guide apparatus 10 provides a cable protection system (CPS).

The guide apparatus 10 comprises a plurality of elements 12 locatable along the length of the elongate member, with each element 12 extending around the elongate member.

A plurality of elongate link members 14 extend between elements 12. Only some of the elongate link members 14 are labelled.

The elongate link members 14 are spaced from each other around the elements 12. In the illustrated examples, the elongate link members 14 are spaced equidistant from one another.

The elongate link members 14 permit limited relative movement of the respective elements 12, such that the guide apparatus 10 permits limited bending of the elongate member.

A straight condition of the guide apparatus 10 is illustrated in FIG. 1. A bent condition of the guide apparatus 10 is illustrated in FIGS. 2 and 3. In a bent condition of the guide apparatus 10, the elements 12 have moved apart on the outside of the bend. At the same time, the elements 12 have moved closer together on the inside of the bend.

The guide apparatus 10 further comprises a plurality of spacers 16, wherein the spacers 16 are disposed between the elements 12. The spacers 16 extend around the elongate member. The end-to-end length of the spacers 16 is greater than the end-to-end length of the elements 12.

The spacers 16 comprise guide formations 18, through which guide formations 18 the elongate link members 14 extend between the elements 12.

As illustrated, in some examples the spacers 16 comprise at least six guide formations 18. The guide formations 18 are through holes which extend through the spacers 16 from one end to the other. The guide formations 18 are spaced from each other around the spacers 16. The guide formations 18 may be spaced equidistant from one another.

In the illustrated example, each of the plurality of elongate link members 14 is connected to at least two elements 12. Fastening means 20 engage with the elongate link members 14 to connect the elongate link members 14 to the elements 12.

For example, each of the four visible elongate link members 14 in FIG. 5 are connected to elements 12 on either side of a spacer 16 by fastening means 20. The elements 12 therefore provide an anchoring function.

In the illustrated example, the fastening means 20 locate through openings 24 in the elements 12 to engage with the elongate link members 14.

FIGS. 12 and 13 illustrate an example fastening means 20 in the form of a connecting pin 22. In the illustrated example, the fastening means 20 is elongate. In the illustrated example, the fastening means 20 comprises a void 38. As illustrated, the void 38 may be an elongate central through hole 39 extending from one end of the fastening means 20 to the other.

Parts of the guide apparatus 10 subject to a relatively low load in use may comprise fastening means 20 made of polymer. Parts of the guide apparatus 10 subject to a relatively high load in use may comprise fastening means 20 made of a metallic material, or a high-performance polymer. Accordingly, the guide apparatus 10 may comprise fastening means 20 made of different materials at different parts of the guide apparatus 10 to provide different material properties. Such an arrangement can significantly reduce costs because the more expensive metallic or high-performance polymer fastening means 20 are used in the guide apparatus 10 only where specifically required. Accordingly, the fastening means 20 may be made of a polymer, for example, for low load applications. Alternatively, in higher load applications the fastening means 20 may be made of a metallic material, which may be corrosion resistant.

Openings 24 in the elements 12 are best illustrated in FIGS. 9 to 11. In the illustrated examples, openings 24 in the elements 12 extend through the element 12, i.e., the openings 24 are through holes.

In the illustrated example, the elements 12 and the spacers 16 are disposed end to end. As best illustrated in FIGS. 7 and 8, the ends of the spacers 16 each define a male formation 28. As best illustrated in FIGS. 9 to 11, the ends of the elements 12 each define a female formation 30.

The male formations 28 on each end of the spacers 16 are locatable in female formations 30 of adjoining elements 12. The male and female formations 28, 30 may provide a ball and socket interconnection. The male and female formations 28, 30 respectively provide substantially spherical load surfaces and thus provide a substantially spherical joint. The spherical joint can only react in compression.

The male and female formations 28, 30 are configured to permit a predetermined amount of relative pivotal movement between spacers 16 and adjacent elements 12.

In the illustrated example, the male formation 28 is an outwardly curved engagement portion 32 which provides the substantially spherical load surface. The female formation 30 is an inwardly curved engagement portion 34 which provides the substantially spherical load surface. In use the outwardly curved engagement portion 32 and the inwardly curved engagement portion 34 therefore provide the substantially spherical joint which can only react in compression.

In use, in a straight condition of the guide apparatus 12 the elements 12 and spacers 16 may move axially forwards and backwards in a substantially straight line. In this condition, the spherical joint equally distributes the compressive load between the outwardly curved engagement portion 32 and the inwardly curved engagement portion 34, which is a relatively large surface area.

In use, in a bent condition of the guide apparatus 12, the elements 12 and spacers on the inside of the bend are in compression at the in use lower part of these components. In this condition, the spherical joints equally distribute the compressive load between the in use lower part of the outwardly curved engagement portion 32 and the in use lower part of the inwardly curved engagement portion 34.

In a bent condition of the guide apparatus 10, on the inside of the bend, the outwardly curved engagement portions 32 of each end of the spacer 16 will engage against the inwardly curved engagement portions 34 of adjoining elements 12, thereby limiting the amount of bending, and preventing damage or stress points.

The elements 12 comprise adjoining openings 36 extending into the openings 24.

FIGS. 9 and 10 illustrate an element 12 comprising twelve openings 24 through which fastening means 20 are locatable to engage with elongate link members 14 as described above. In the example illustrated in FIGS. 9 and 10, the adjoining openings 36 extend into the openings 24 from either one end of the element 12 or from the other end of the element 12. The adjoining openings do not extend through the element 12, but instead terminate in the element 12. The element 12 of FIGS. 9 and 10 may be referred to as an anchor plate, and can be used to join to other structures.

FIG. 11 illustrates an element 12 instead comprising six openings 24 through which fastening means 20 are locatable to engage with elongate link members 14 as described above. In the example illustrated in FIG. 11, the adjoining openings 36 extend through the element 12 from one end to the other, i.e., the adjoining openings 36 are through holes. The element 12 of FIG. 11 may be referred to as a through anchor plate. A through anchor plate 12 will never be at an end of a string as it is not possible to connect anything to it.

Accordingly, the elements 12 comprising six openings 24 comprise six adjoining openings 36 and the elements 12 comprising twelve openings 24 comprise twelve adjoining openings 36.

In use, elongate link members 14 extend through adjoining openings 36 into the openings 24 as illustrated, for example, in FIGS. 3, 5 and 6.

With reference to the bent part of the guide apparatus 10 illustrated in FIG. 5, each of the elements 12 visible comprise twelve openings 24. With reference to the second element 12 from the left side of the illustration, an elongate link member 14 extends from a proximal element 12 (located to the left of the element 12 in question), through a guide formation 18 of the spacer 16, and through the uppermost adjoining opening 36 into the opening 24. A fastening means 20 locates in the opening 24 to engage with elongate link member 14.

Although not visible in the illustration, an adjacent elongate link member 14 extends from a proximal element 12 (located to the right of the element in question), through a guide formation 18 of the spacer 16, and through the adjoining opening 36 immediately below the uppermost adjoining opening 36 into the opening 24. A fastening means 20 locates in the opening 24 to engage with elongate link member 14.

Accordingly, adjacent elongate link members 14 on at least some of the elements 12 extend in opposite directions to each other, to each connect to just one other respective element 12, i.e., an element 12 most proximal. Accordingly, six elongate link members 14 extend between each element 12 with twelve openings 24, i.e., six in one direction and six in the opposite direction. However, each element 12 with twelve openings 24 is connected to twelve elongate link members 14 by fastening means 20 locating through each opening 24 as described above, i.e., six which extend from the element 12 in one direction and six which extend from the element 12 in the opposite direction. Accordingly, at least twelve elongate link members are connected to at least some of the elements 12.

As best illustrated in FIG. 3, in such examples the guide apparatus 10 is configured such that the guide formations 18 of proximal spacers 16 are off-set, i.e., not aligned.

The configuration of the elements 12 enabling the above off-set arrangement is best illustrated in FIG. 10 in which the uppermost adjoining opening 36 extends into an opening 24 from one end of the element 12 and the adjoining opening 36 immediately below the uppermost adjoining opening 36 extends into an opening 24 from the other end of the element 12.

In the example of FIG. 6, the element 12 on the left side of the illustration comprises twelve openings 24 and the remaining elements comprise six openings. Adjacent elongate link members 14 extend from the element 12 comprising twelve openings through a plurality of elements 12 comprising six openings 24 because the adjoining openings 36 in each element 12 are through holes. Accordingly, at least some of the elongate link members 14 extend through a plurality of elements 12, wherein the elongate link members 14 are connected to each of the plurality of elements 12 through which they extend. As best illustrated in FIG. 6, in such examples the guide apparatus 10 is configured such that the guide formations 18 of proximal spacers 16 are aligned.

In the illustrated example, six elongate link members 14 extend between each element 12 with six openings 24. Each element 12 with six openings 24 is connected to six elongate link members 14 by fastening means 20 locating through each opening 24 as described above. Accordingly, at least six elongate link members are connected to at least some of the elements 12.

In some examples, the guide apparatus 10 may comprise only elements 12 comprising twelve openings 24 or alternatively may comprise only elements 12 comprising six openings 24.

In other examples, for instance as illustrated in FIG. 3, some parts of the guide apparatus 10 comprise elements 12 comprising six openings 24 and other parts of the guide apparatus 10 comprise elements comprising twelve openings 24. Accordingly, in some examples at least six elongate link members 14 are connected to some of the elements 12 and at least twelve elongate link members 14 are connected to others of the elements 12.

The provision of elements 12 comprising six openings 24 in parts of the guide apparatus 10 (rather than elements 12 comprising twelve openings 24) correspondingly reduces the numbers of fasteners 20 and elongate link members 14 required and thus reduces costs and potential points of failure. The provision of elements 12 comprising twelve openings 24 in parts of the guide apparatus 10 (rather than elements 12 comprising six openings 24) provides increased performance in those parts of the guide apparatus 10. Increased performance may be required in parts of the guide apparatus 10 which in use bend, as illustrated.

Regarding elements 12 comprising at least six openings 24, such a configuration allows for a degree of redundancy. For example, if any one of the elongate link members 14 break, the two adjacent elongate link members 14 take half the load and thus prevent failure of the guide apparatus 10.

In some examples, for instance as illustrated in FIG. 11, the openings 24 in at least some of the elements 12 are at an angle of 90 degrees to the adjoining openings 36. Accordingly, the openings 24 and the adjoining openings 36 are perpendicular.

In other examples, for instance as illustrated in FIGS. 9 and 10, the openings 24 in at least some of the elements are at an angle other than 90 degrees to the adjoining openings 36. Accordingly, the openings 24 and the adjoining openings 36 are not perpendicular. In such examples, the openings 24 are therefore angled into the elements 12. The openings 24 may be angled into the elements 12 at an angle of 2 to 10 degrees, and preferably 5 degrees.

In a bent condition of the guide apparatus 10 at least part of the guide apparatus 10 is bent in an arc. The angle of the openings 24 determines the angle of the fastening means 20 locating through the opening 24. The fastening means 20 therefore engage with the elongate link members 14 according to the angle of the openings 24. In examples in which the elongate link members 14 are straps or rope, and thus comprise fibers, the selected angle of the openings in elements 12 in the bent part of the guide apparatus 10 ensures that all fibers are taking an equal load when the guide apparatus 10 is in a bent condition. An unequal load may lead to a catastrophic failure because the fibers of the straps or rope may unzip. Accordingly, openings 24 at an angle other than 90 degrees to the adjoining openings 36 avoid a situation where fibers are taking an unequal load when the guide apparatus 10 is in a bent condition

FIG. 14 illustrates a guide apparatus 10 according to examples of the disclosure in use subsea on an elongate member. In the illustrated example, the elongate member is a subsea cable. The guide apparatus 10 provides a cable protection system (CPS). The guide apparatus 10 is connected to a structure 40. The guide apparatus 10 extends downwardly from the point of connection to the structure 40 and is caused to bend by contacting the seabed 42. The guide apparatus 10 extends along the seabed 42 before bending to extend downwardly into the seabed 42. Accordingly, in the illustrated example some parts of the guide apparatus 10 are in a bent condition and other parts are in a straight condition. Furthermore, some parts of the guide apparatus 10 are contacting the seabed 42, some parts are buried beneath the seabed 42 and some parts do not contact the seabed 42.

The elements 12 and/or spacers 16 may be made of a plastics material, for instance polyurethane. In some examples the elements 12 and spacers 16 are made of different materials, for instance, different plastics materials. Different grades of polyurethane and/or different additives may be used depending on the properties and/or performance required.

Elements 12 and/or spacers 16 made of materials, such as polyurethane, may be tailored to provide optimum levels of impact protection, compressive strength, tensile strength and/or abrasion resistance. Elements 12 and/or spacers 16 may also be made of different materials at different parts of the guide apparatus 10 to provide different material properties.

For example, in some applications the guide apparatus 10 is used for elongate members such as subsea pipelines or cables as illustrated in FIG. 14. In such applications, the guide apparatus 10 will move due to wave motion, for instance, backwards and forwards every few seconds. Accordingly, spacers 16 which lie on the seabed 42 may move on a layer comprising rocks and/or sand depending on the environment. Layers comprising rocks present sharp edges against the spacers 16 which can cause abrasion. Accordingly, in such examples, the spacers 16 may be made of a material optimized for abrasion resistance. Such materials may be polyurethane comprising additives.

In other examples, spacers 16 which do not contact the seabed 42 in use may be made of different materials. For instance, the spacers 16 may be made of polyurethane with a polyethylene shell. In such examples, the polyethylene shell may first be manufactured by rotational molding followed by filling the polyethylene shell with polyurethane which reduces the tooling required.

In some examples a filler material is located in at least some of spacers 16, i.e., to provide a ballasted spacer 16. The filler material is either lighter or heavier than water to respectively provide buoyancy or assist with sinking in water and on bottom stability. The filler materials may be concrete. On bottom stability also reduces movement, for example rolling movement caused by wave motion, and thus reduces abrasion, for instance, on rocks. The spacers 16 may be segmented. The filler may be located in one or more of the segments. Accordingly, the filler material may be provided on one side only of the spacers 16, for example, to provide orientation thereof in water and on bottom stability.

In other examples, the spacers 16 may be made of a material with optimized compressive strength.

The elements 12 may be made of a material optimized for shear properties because in use the elements 12 may be subject to a double shear. For example, at or towards the point of connection to a structure 40 as illustrated in FIG. 14, the guide apparatus 10 will experience a very high bending moment load, for instance 100 kilonewton meters (kN·m). The bending moment load experienced by the guide apparatus 10 progressively decreases the further away from the point of connection to the structure 40. Within a few meters away from the point of connection the bending moment load may only be 5 to 10 kN·m. Accordingly, the elements 12 closest to the point of connection to the structure 40 could be made of a metallic material or a high-performance polymer capable of withstanding a very high moment load. However, elements 12 located further from the point of connection (for example parts of the guide apparatus 10 in a straight condition) which in use will either not be subject to a bending moment load or only to a relatively small bending moment load could instead be made of a different material, for instance, a relatively less expensive rubber.

The elongate link members 14 may be in the form of straps, rope or pins. In some examples, the elongate link members 14 are made of an elastic material. The rope may be a high-modulus polyethylene (HMPE) rope, ultra high modulus polyethylene (UHMPE), (i.e., Dyneema® rope), wire rope (super duplex or stainless or galvanized), or aramid co-polymer. The straps may be Roblon® straps.

HMPE, UHMPE and aramid co-polymer are particularly suitable for subsea use. The rope, straps or pins may though be formed of any material. The selection of material depends on the particular application of the guide apparatus 10.

As best illustrated in FIG. 15, in some examples the fastening means 20 extend through openings 26 in the elongate link members 14 to engage with the elongate link members 14. Accordingly, the fastening means 20 locate in the openings 26.

The openings 26 may be defined by an attachment structure 27, which may be substantially ring shaped.

As illustrated in FIG. 16, in some examples wherein the elongate link member 14 is a rope 29, the attachment structure 27 may be formed of a polymer. The rope 29 comprises a plurality of braided or twisted strands 31. The attachment structure 27 defines the opening 26 through the rope 29 between the rope strands 31. The strands 31 are fixedly held in the attachment structure 27 by being encased within the polymer. Accordingly, the rope strands 31 are set in the polymer. The attachment structure 27 may be referred to as an eyelet.

In examples of the disclosure, the fibers of the strands 31 of rope 29 fixedly held in the in the attachment structure 27 by being encased within the polymer are impregnated by the casting resin used to form the polymer. Accordingly, the fibers of the strands 31 of rope 29 are intimately associated with the polymer in a composite structure. This increases the shear strength of the polymer by distributing the load applied to the rope 29.

As best illustrated in FIG. 3, in some examples the elongate link members 14 are different at different parts of the guide apparatus 10, for example, to provide different stiffnesses and/or permit different amounts of flexing of an elongate member and/or depending on the load the different parts of the guide apparatus 10 are subjected to in use.

For example, with regard to FIG. 14, the part of the guide apparatus 10 at or towards the point of connection to a structure 40, and thus in a bent condition, comprises elongate link members 14 in the form of straps (as illustrated in FIGS. 3 and 5) which can withstand a relatively high bending moment load, for instance up to 100 kN·m. With regard to FIG. 6, this part of the guide apparatus 10 is in a straight condition which in use will either not be subject to bending moment load or only to a relatively small bending moment load. Accordingly, this part of the guide apparatus 10 instead comprises elongate link members 14 in the form of pins which are less able to withstand high bending moment load but are also less expensive than the aforementioned straps.

The elements 12 and/or spacers 16 may be formed in a single part. The elements 12 and spacers 16 may define a closed loop around the elongate member.

During assembly of the guide apparatus 10 the elements 12 and spacers 16 may be moved axially along an elongate member to a required position. In some examples, for ease of transportation the guide apparatus 10 will comprise a plurality of parts, i.e., sub-assemblies, for example, three or more parts. At location, for example on a cable-laying vessel, the guide apparatus 10 is assembled by fastening the parts together. In some examples, a messenger line is then pulled through the assembled guide apparatus 10. The messenger line is attached to the elongate member via a grip, for instance a cable grip, following which the elongate member is pulled into the guide apparatus 10.

With regard to FIG. 10, arrows are illustrated pointing towards and away from the element 12. The arrows pointing towards the element 12 indicate the reactions due to a tensile force. The arrows pointing away from the element 12 indicate the reactions due to a compressive force. With a moment load, curved guide apparatus 10, the central part of the element 12 will be under compression (arrows pointing away from the element 12) and the outer arc tethers will be in tension (arrows pointing towards the element 12), to react the moment.

As illustrated in FIGS. 17 to 25, in some examples at least some of the spacers 16 comprise ground engaging means 44. In the example illustrated in FIGS. 17 and 18, three of the spacers 16 comprise ground engaging means 44. In other examples, a different number of spacers 16 may comprise ground engaging means 44.

In the illustrated example, the ground engaging means 44 comprises projections 46 extending radially from the spacer 16. In some examples, two projections 46 are provided. Accordingly, in some examples the ground engaging means 44 comprises at least two projections 46 extending radially from the spacer 16. The two projections 46 may be pair. The two projections 46 may be referred to as feet.

The projections 46 may have a curved profile. The projections 46 may be bell-shaped in cross section. In the illustrated example, the projections 46 comprise two flat faces 48 and one curved face 50, wherein the curved face 50 is disposed between the two flat faces 48. The configuration of the ground engaging means 44, i.e., of the projections 46, causes turbulence, i.e., vortexes, subsea, which in use causes the ground engaging means 44 to displace sediment on the seabed 42 and thus to become buried to an extent in the seabed 42, i.e., self-burial. As a consequence, movement of the guide apparatus by the action of the sea is limited or prevented which prevents damage to the guide apparatus 10 and enclosed elongate member, for instance from abrasion against the scour protection. Furthermore, the guide apparatus 10 is correctly orientated in use.

In use, the projections 46 extend radially downwardly from the lower half of the spacer 16. Accordingly, the projections 46 are provided below the center line of the spacer 16.

In some examples, for instance as illustrated in FIGS. 19 and 20, the ground engaging means 44 is integrally formed with the spacer 16. In such examples the spacer 16 and the ground engaging means 44 are made of the same material, which may be concrete.

Alternatively, as illustrated in FIGS. 21 and 22, the ground engaging means 44 is attachable to the spacer 16 by fastening means 52. Accordingly, the ground engaging means 44, i.e., the projections 46, in such examples are individual parts attachable to the spacer 16 by fastening means 52. The fastening means 52 may be a nut and bolt fastener. As described above, since the spacer 16 can only react to loads in compression, the ground engaging means 44 can be attached by fastening means 52 to the spacer 16 without compromising structural integrity.

The ground engaging means 44, i.e., the projections 46, may be made of concrete or may be made of a metallic material. In examples, wherein the ground engaging means 44, i.e., the projections 46, are individual parts attachable to the spacer 16 by fastening means 52, the spacer 16 and the ground engaging means 44 may be made of the same material or may be made of different materials.

In some examples, at least some of the spacers 16 are made of concrete. In other examples, as noted above, the spacers 16 may be made of a polymer such as polyurethane. In examples wherein the spacers 16 may be made of a polymer such as polyurethane, the ground engaging means 44 may be made of a high-density material such as concrete. The ground engaging means 44 made of a high-density material such as concrete moves the center of gravity downwards and reduces rolling and overturning of the guide apparatus 10.

The use of high-density materials such as concrete or metal for the spacer 16 and/or ground engaging means 44 assists with sinking in water and on bottom stability thus limiting or preventing movement of the guide apparatus 10 by the action of the sea, which prevents damage to the guide apparatus 10 and enclosed elongate member. A high-density material is defined as a material with a density greater than 7000 kg/m³.

As illustrated in FIGS. 23 to 25, in some examples the guide apparatus 10 comprises positioning rings 54 in at least some of the spacers 16 and/or elements 12 for positioning the elongate member. The positioning rings are located in the spacers 16 and/or elements 12 co-axially with the spacers 16 and/or elements 12. The positioning rings 54 are configured to cause the elongate member to adopt the neutral axis in the guide apparatus 10. Accordingly, the elongate member is protected from movement of the guide apparatus by the action of the sea which may otherwise put the elongate member under compression or tension and thus cause damage. Accordingly, there is no differential movement between the elongate member and the guide apparatus 10, thereby preventing or at least reducing abrasion.

The positioning rings 54 are made of a polymeric material. The positioning rings 54 are hydrophilic. The positioning rings 54 may comprise a profiled inner circumference 56, which in the illustrated example is castellated. The positioning ring 54 may be a seal or perform the function of a seal. The positioning rings 54 are configured to expand in seawater, for instance up to 10 times their dry volume. The inner circumference 56 has a low coefficient of friction thereby reducing lateral and longitudinal abrasion. A further advantage of the use of positioning rings 54 is that any sediment in the internal space in a spacer 16 or element 12 accumulates adjacent to the positioning rings 54 and thus away from the elongate member, which could otherwise be damaged by abrasion on the sediment.

There is thus described a guide apparatus 10 with a number of advantages as described above. Furthermore, the provision of elements 12, spacers 16, elongate link members 12 and/or fastening means 20 made from different materials and/or with a different construction at different parts of the guide apparatus 10 depending on the properties and/or performance required minimizes costs because the highest performance components (and thus highest cost components) are only selectively used where required. For example, a guide apparatus 10 according to examples of the disclosure may be 30 meters in length. However, high performance elements 12, spacers 16, elongate link members 12 and/or fastening means 20 may only be required (and thus only provided) in about seven meters of this length resulting in a significant cost saving overall.

Furthermore, having at least six openings 24 allows for one of the longitudinal tethers (i.e., elongate link members 14) to break and the two adjacent ones can still react a bending moment. With a traditional bend restrictor design, if one fastener or bend restrictor fails the entire system fails. This is due to the load path. When in tension the strain has to go around the neck and collar of each bend restrictor to get to a bolt interface, then this then goes around to the next neck/collar interface. Creating bending moments, tensile stress, very high contact stresses in polymers and prone to manufacturing errors. In examples of the disclosure, all the load is put directly through the tension members to react half the moment and all the spacers 16 into compression (large spherical surface interface) to react the other half of the moment in a direct simple load path.

Although embodiments of the present disclosure have been described in the preceding paragraphs with reference to various examples, it should be appreciated that modifications to the examples given can be made without departing from the scope of the disclosure as claimed. The size and configuration of the elements 12, spacers 16, elongate link members 14 and/or fastening means 20 is dependent on the particular application and, for instance the diameter of the elongate member. For example, materials of various components of the guide apparatus 10 can be changed for improved impact protection or improved abrasion resistance or improved bending moment capacity or low cost just to create a duct which is then ‘rock’ dumped over as part of the scour protection process.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

The term “comprise” is used in this document with an inclusive not an exclusive meaning. That is any reference to X comprising Y indicates that X may comprise only one Y or may comprise more than one Y. If it is intended to use “comprise” with an exclusive meaning then it will be made clear in the context by referring to “comprising only one . . . ” or by using “consisting”.

In this brief description, reference has been made to various examples. The description of features or functions in relation to an example indicates that those features or functions are present in that example. The use of the term “example” or “for example” or “may” in the text denotes, whether explicitly stated or not, that such features or functions are present in at least the described example, whether described as an example or not, and that they can be, but are not necessarily, present in some of or all other examples. Thus “example”, “for example” or “may” refers to a particular instance in a class of examples. A property of the instance can be a property of only that instance or a property of the class or a property of a sub-class of the class that includes some but not all of the instances in the class. It is therefore implicitly disclosed that features described with reference to one example but not with reference to another example, can where possible be used in that other example but does not necessarily have to be used in that other example.

Whilst endeavoring in the foregoing specification to draw attention to those features of the disclosure believed to be of particular importance it should be understood that the Applicant claims protection in respect of any patentable feature or combination of features hereinbefore referred to and/or shown in the drawings whether or not particular emphasis has been placed thereon.

1. A guide apparatus for an elongate member, the guide apparatus comprising:
a plurality of elements locatable along the length of the elongate member, with each element extending around the elongate member;
a plurality of elongate link members extending between elements, the elongate link members being spaced from each other around the elements, the elongate link members permitting limited relative movement of the respective elements, such that the guide apparatus permits limited bending of the elongate member;
a plurality of spacers, wherein the spacers are disposed between the elements, the spacers extending around the elongate member, wherein the spacers comprise guide formations, through which guide formations the elongate link members extend between the elements; and
a plurality of fasteners, for engaging with the plurality of elongate link members to connect the plurality of elongate link members to the plurality of elements, wherein each of the fasteners extends through an opening in an elongate link member, from the plurality of elongate members, to engage with that elongate link member.

2. A guide apparatus according to claim 1, wherein each of the plurality of elongate link members is connected to at least two elements.

3. A guide apparatus according to claim 1, wherein adjacent elongate link members on at least some of the elements extend in opposite directions to each other, to each connect to just one other respective element.

4. A guide apparatus according to claim 1, wherein at least some of the elongate link members extend through a plurality of elements, wherein the elongate link members are connected to each of the plurality of elements through which they extend.

5. (canceled)

6. A guide apparatus according to claim 1, wherein the guide apparatus comprises fastening means made of different materials at different parts of the guide apparatus to provide different material properties.

7. A guide apparatus according to claim 1, wherein the fastening means locate through openings in the elements to engage with the elongate link members.

8. A guide apparatus according to claim 7, wherein the elements comprise adjoining openings extending into the openings, wherein elongate link members extend through the adjoining openings into the openings.

9. A guide apparatus according to claim 8, wherein in at least some of the elements, the openings are at an angle of 90 degrees to the adjoining openings.

10. (canceled)

11. (canceled)

12. A guide apparatus according to claim 1, wherein the elements and the spacers are disposed end to end, wherein the ends of the spacers each define a male formation and the ends of the elements each define a female formation, wherein the male formations on each end of the spacers are locatable in female formations of adjoining elements.

13. A guide apparatus according to claim 12, wherein the male and female formations provide a ball and socket interconnection, and wherein the male and female formations are configured to permit a predetermined amount of relative pivotal movement between spacers and adjacent elements.

14. A guide apparatus according to claim 1, wherein the elongate link members are different at different parts of the apparatus, to provide different stiffnesses and/or permit different amounts of flexing of an elongate member and/or depending on the load the different parts of the guide apparatus are subjected to in use.

15. (canceled)

16. (canceled)

17. (canceled)

18. A guide apparatus according to claim 1, wherein the elements and/or spacers are made of different materials at different parts of the guide apparatus to provide different material properties.

19. A guide apparatus according to claim 1, wherein a filler material is located in at least some of spacers, wherein the filler material is either lighter or heavier than water to respectively provide buoyancy or assist with sinking in water and on bottom stability, and wherein the filler material is provided on one side only of the spacers to provide orientation thereof in water.

20. A guide apparatus according to claim 1, wherein at least some of the spacers comprise ground engaging means.

21. A guide apparatus according to claim 20, wherein the ground engaging means comprises projections extending radially from the spacer.

22. A guide apparatus according to claim 20, wherein the ground engaging means are integrally formed with the spacer.

23. A guide apparatus according to claim 21, wherein the ground engaging means are attachable to the spacer by fastening means.

24. (canceled)

25. A guide apparatus according to claim 1, wherein the guide apparatus comprises positioning rings in at least some of the spacers and/or elements for positioning the elongate member, wherein the positioning rings are configured to cause the elongate member to adopt the neutral axis in the guide apparatus.

26. A guide apparatus for an elongate member, the guide apparatus comprising:
a plurality of elements locatable along the length of the elongate member, with each element extending around the elongate member;
a plurality of elongate link members extending between elements, the elongate link members being spaced from each other around the elements, the elongate link members permitting limited relative movement of the respective elements, such that the guide apparatus permits limited bending of the elongate member;
a plurality of spacers, wherein the spacers are disposed between the elements, the spacers extending around the elongate member, wherein the spacers comprise guide formations, through which guide formations the elongate link members extend between the elements; and
fastening means, for engaging with the elongate link members to connect the elongate link members to the elements, wherein the fastening means extend through openings in the elongate link members to engage with the elongate link members.

27. A guide apparatus for an elongate member, the guide apparatus comprising:
a plurality of elements locatable along the length of the elongate member, with each element extending around the elongate member, wherein each of the elements comprises openings and adjoining through hole openings extending into the openings;
a plurality of elongate link members extending between elements, the elongate link members being spaced from each other around the elements, the elongate link members permitting limited relative movement of the respective elements, such that the guide apparatus permits limited bending of the elongate member;
a plurality of spacers, wherein the spacers are disposed between the elements, the spacers extending around the elongate member, wherein the spacers comprise guide formations, through which guide formations the elongate link members extend between the elements, wherein at least some of the elongate link members extend through the adjoining through hole openings into guide formations of spacers; and
a plurality of fasteners, for engaging with the elongate link members, which locate in the openings in the elements to connect the elongate link members, extending through the adjoining through hole openings, to the elements.
